(19) United States
(12) Patent Application Publication
(10) Pub. No.: US 2006/0232495 A1
(43) Pub. Date: Oct. 19, 2006

(54) Dual panel display

(75) Inventors: Wei-Chih Chang, Hsinchu Hsien (TW); An Shih, Changhua (TW)

Correspondence Address: LIU & LIU, 444 S. FLOWER STREET, SUITE 1750, LOS ANGELES, CA, 90071, US

(73) Assignee: Toppoly Optoelectronics Corp.

(21) Appl. No.: 11/110,139

(22) Filed: Apr. 19, 2005

(51) Int. Cl. G09G 5/00

(52) U.S. Cl. 345/1.1

(57) ABSTRACT

A dual panel display including a first panel including a first display area thereon, a second panel including a second display area thereon, a first flexible printed circuit (FPC), an electronic element and a second FPC is provided. The electronic element is mounted on the second panel and connected to the first FPC, and the second FPC is connected to the first panel. In addition, the second FPC is connected to the electronic element or a side of the second panel that is opposite to the first FPC, wherein when the second FPC is connected to the side of the second panel, a length of the first panel is longer than a length of the second panel.

### BACKGROUND OF THE INVENTION

1. Field of the Invention

The present invention is related to a dual panel display. More particularly, the present invention relates to a dual panel display having a shorter longitudinal total length.

2. Description of Related Art

As the semiconductor technology advances, the portable electronic devices such as mobile phone or notebook have become thinner and lighter and have more functions. For example, the display of the mobile phone or the notebook is colorized and has higher resolution recently. However, the function of the mobile phone or the notebook may be further improved.

For example, in order to reduce the size of the mobile phone, the mobile phone is designed to have a body and a flip lid, wherein the keypad is mounted on the inside surface of the body and the display is mounted on the inside surface of the flip lid. Therefore, when the mobile phone is not used, the flip lid may be covered on the body and thus the keypad and the display may be protected from dirt, water, or other inadvertent impact or actuation. However, when the mobile phone receives a call or a message, it is not convenient for the user to answer the call or check the message since the flip lid has to be opened to look the display or the press the keypad. In addition, if the user needs only to look the time, it is not convenient for the user since the flip lid has to be opened. Therefore, a mobile phone has dual panel display is developed to solve the problem.

FIG. 1 is a schematic cross-sectional view of a conventional dual panel display. Referring to FIG. 1, a dual panel display 100 includes a main panel 102 having a main display area 104, a sub panel 106 having a sub display area 108, a backlight module 110, a driver integrated circuit (IC) 112, a flexible printed circuit (FPC) 114 and a FPC 116. The dual panel display 100 may be connected to a control circuit 118. In general, the length of the main panel 102 is longer than that of the sub panel 106 since the main display 104 is adopted for displaying an image or the whole message, but the sub panel 106 is only adopted for displaying some simplified messages. Referring to FIG. 1, the data signal transmitted from the control circuit 118 via the FPC 116 is received by the driver IC 112, and then the main panel 102 is driven by the driver IC 112. In addition the sub panel 106 is also driven by the driver IC 112 via the FPC 114.

### SUMMARY OF THE INVENTION

Therefore, the present invention is directed to a dual panel display having a shorter total length by connecting the electronic element (such as drive IC) to the panel having a shorter length, the total length of the dual panel display may be kept to a minimum. The total length of the display may be reduced when using panels that are no bigger than those used in the prior art, or for the same overall length of the display as the prior art, longer panels may be used.

The present invention is also directed to a dual panel display having a shorter total length by providing two FPCs at the same side of the shorter panel.

According to one embodiment of the present invention, a dual panel display comprising, for example but not limited to, a first panel comprising a first display area thereon, a second panel comprising a second display area thereon, a first flexible printed circuit (FPC), an electronic element and a second FPC is provided. It should be noted that a length of the first panel is longer than a length of the second panel. In addition, the electronic element is connected to the second panel, and the first FPC is connected the electronic element, and the second FPC is connected between the first panel and the second panel.

In one embodiment of the present invention, the electronic element is mounted on the second panel.

In one embodiment of the present invention, the electronic element is mounted on a printed circuit board (PCB) and connected to the PCB, wherein the electronic element is connected to the second panel via a third FPC connected to the PCB and the second panel.

In one embodiment of the present invention, the second FPC is connected to the second panel at a side of the second panel that is opposite to the first FPC.

In one embodiment of the present invention, the first panel or the second panel is a liquid crystal display (LCD) or a light emitting diode (LED) display. In addition, when the first panel and the second panel are liquid crystal displays, the dual panel display further comprises a backlight module disposed between the first panel and the second panel for providing a light source to the first panel and the second panel.

In one embodiment of the present invention, the dual panel display further comprises a multiplexer mounted on the first panel. In another embodiment of the present invention, the multiplexer comprises an 1:3 multiplexer, an 1:6 multiplexer or an 1:9 multiplexer.

In one embodiment of the present invention, a width of the first panel is equal to, shorter or longer than a width of the second panel.

In one embodiment of the present invention, the electronic element comprises a passive element or an active element, wherein the active element includes a drive integrated circuit (IC).

According to one embodiment of the present invention, a dual panel display comprising, for example but not limited to, a first panel, a second panel, a first flexible printed circuit (FPC), an electronic element and a second FPC is provided. The electronic element is connected to the second panel and the first FPC, and the second FPC is connected to the first panel and to the electronic element.

Accordingly, in the present invention, since the electronic element and the first FPC that connected to the electronic element are mounted on the second panel having a shorter length, the total length of the dual panel display may be reduced. Alternatively, in the present invention, since the electronic element, the first FPC and the second FPC are mounted at a same side of the second panel, the total length of the dual panel display may be reduced, and the utility of space may be increased.

According to one embodiment of the present invention, a dual panel display comprising, for example but not limited to, a first panel comprising a first display area thereon, a second panel comprising a second display area thereon, a first flexible printed circuit (FPC), an electronic element and a second FPC is provided. The electronic element is connected to the second panel and the first FPC, and the second FPC is connected to the first panel. In addition, the second FPC is connected to the electronic element or a side of the second panel that is opposite to the first FPC, wherein when the second FPC is connected to the side of the second panel, a length of the first panel is longer than a length of the second panel.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a conventional dual panel display.

FIG. 2A is a schematic cross-sectional view of a dual panel display according to one embodiment of the present invention, wherein the electronic element is mounted on a panel.

FIG. 2B is a schematic expanded view of a dual panel display of FIG. 2A.

FIG. 3A is a schematic cross-sectional view of a dual panel display according to one embodiment of the present invention, wherein the electronic element is mounted on a PCB.

FIG. 3B is a schematic expanded view of a dual panel display of FIG. 3A.

FIG. 4A is a schematic cross-sectional view of a dual panel display according to another embodiment of the present invention, wherein the electronic element is mounted on a panel.

FIG. 4B is a schematic expanded view of a dual panel display of FIG. 3A.

FIG. 5A is a schematic cross-sectional view of a dual panel display according to another embodiment of the present invention, wherein the electronic element is mounted on a PCB.

FIG. 5B is a schematic expanded view of a dual panel display of FIG. 5A.

### DESCRIPTION OF EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

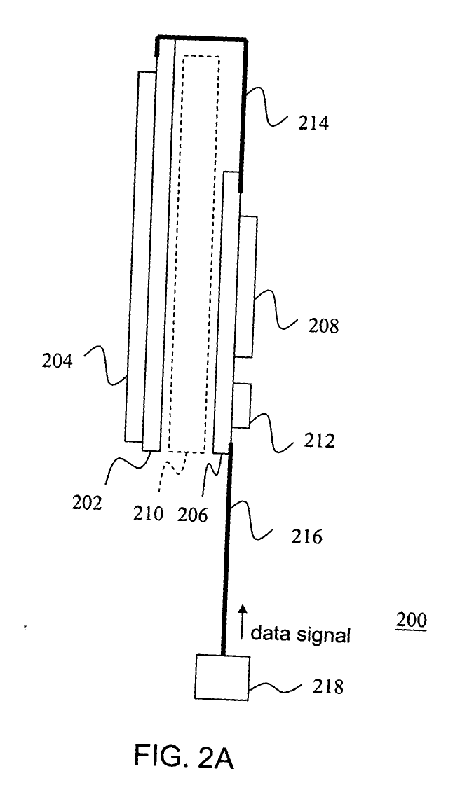

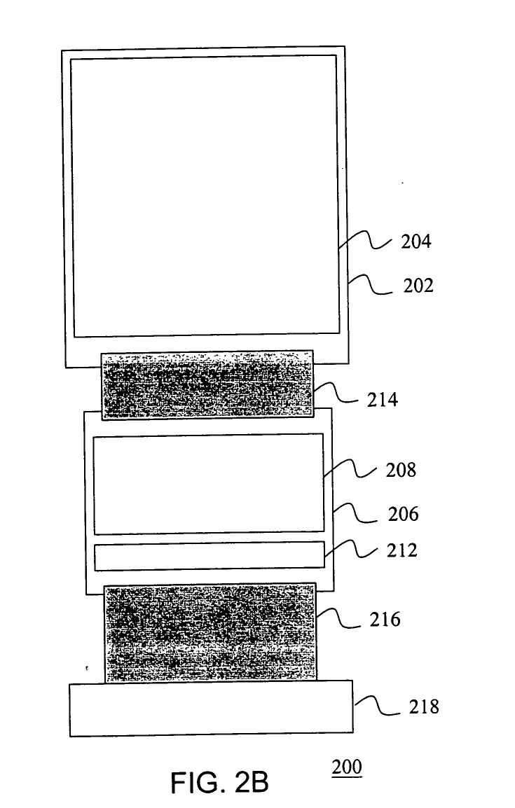

FIG. 2A is a schematic cross-sectional view of a dual panel display according to one embodiment of the present invention, wherein the electronic element is mounted on a panel. Referring to FIG. 2A, a dual panel display 200 comprises, for example but not limited to, a first panel 202 having a first display area 204, a second panel 206 having a second display area 208, a electronic element 212, a flexible printed circuit (FPC) 214 and a FPC 216. The dual panel display 200 may be, for example, connected to a control circuit 218. In one embodiment of the present invention, the first panel 202 or the second panel 206 may be liquid crystal display (LCD), a plasma display, a light emitting diode (LED) display, or other types of displays. When the first panel 202 and the second panel 206 are LCD, a backlight module 210 may be disposed between the first panel 202 and the second panel 206 for providing a light source to the first panel 202 and the second panel 206. In addition, the first panel 202 and the second panel 206 are transparent, reflective or transflective. Furthermore, the electronic element 212 is mounted on the second panel 206, for example. In fact, the electronic element 212 mounted on the second panel 206 could be an active element or a passive element, wherein the active element comprises any kinds of integrated circuits (ICs)(such as drive IC) for any other functions such as latching or signal converting, etc.

FIG. 2B is a schematic expanded view of a dual panel display of FIG. 2A. Referring to FIG. 2B, it is noted that the FPC 214 and the FPC 216 are connected to two opposite sides of the second panel 206 respectively. Therefore, the data signal transmitted from the control circuit 218 via the FPC 216 is received by the electronic element 212, and then the second panel 206 is driven by the electronic element 212. Therefore, the first panel 202 is also driven by the electronic element 212 via the FPC 214. In addition, the length of the first panel 202 is longer than that of the second panel 206, however, the width of the first panel 202 may be equal to, smaller or larger than that of the second panel 206. In one embodiment of the present invention, the first panel 202 may be, for example but not limited to, a main panel that has a relatively bigger display area, and the second panel 206 may be, for example but not limited to, a sub panel that has a relatively smaller display area. The distinction of as to which panel is the main panel and which is the sub panel may not be important. It is important to note that in accordance with the present invention, the space available to the sub panel is advantageously used for placement of other components, such as driver chips, etc.

In one embodiment of the present invention, the dual panel display 200 may be adopted for mobile phone, portable computer or notebook.

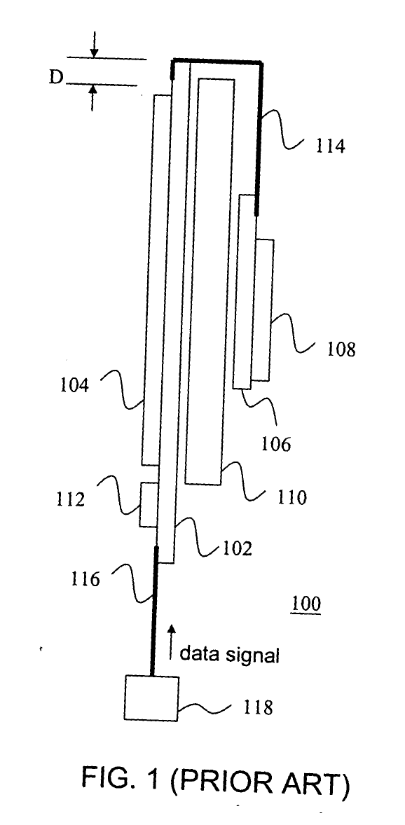

It is noted that, since the electronic element 212 and a substantial portion of the FPC 216 that is connected between the electronic element 212 and the control circuit 218 of FIG. 2A and FIG. 2B are mounted on the second panel 206 that has a shorter length, the total length of the dual panel display 200 may be reduced. For example, the total length of the dual panel display 200 shown in FIG. 2A and FIG. 2B is shorter than that of the dual panel display 100 shown in FIG. 1 for about a length of the electronic element 212.

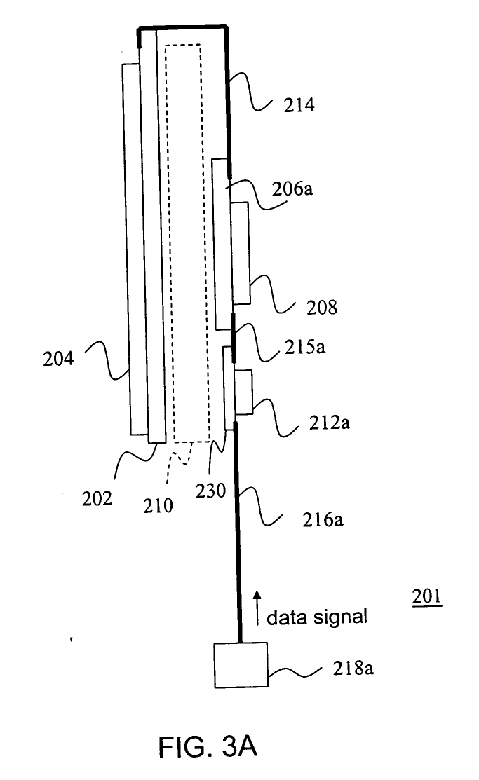

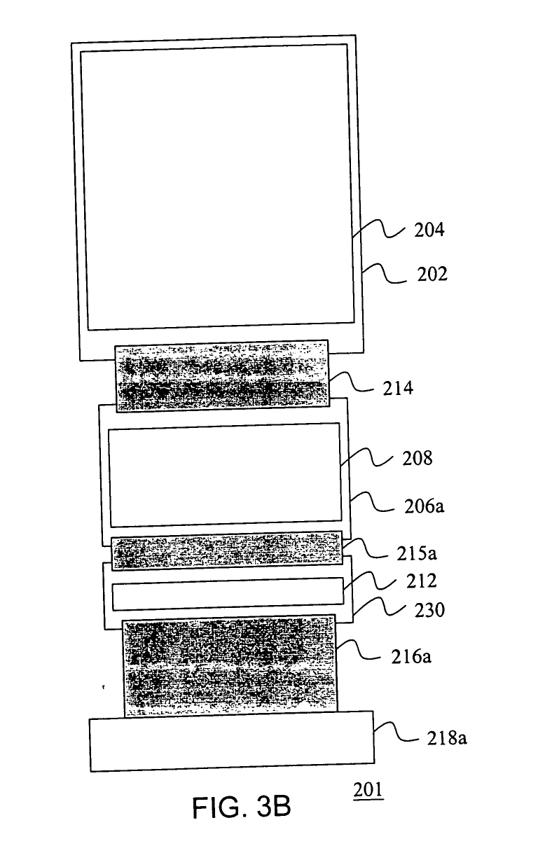

FIG. 3A is a schematic cross-sectional view of a dual panel display according to one embodiment of the present invention, wherein the electronic element is mounted on a PCB. FIG. 3B is a schematic expanded view of a dual panel display of FIG. 3A. Referring to FIGS. 3A and 3B, in one embodiment of the present invention, compared to the above-mentioned dual panel display 200, the electronic element 212a of the dual panel display 201 is mounted on a printed circuit board (PCB) 230 and connected to the PCB 230, wherein the electronic element 212a is connected to the second panel 206a via a third FPC 215a connected to the PCB 230 and the second panel 206a. In addition, the control circuit 218a via the FPC 216a is connected to the PCB 230 to transmit signals to the electronic element 212a and the second panel 206a. The other elements of the dual panel display 201 in FIGS. 3A and 3B are the same with the dual panel display 200 in FIGS. 2A and 2B and the effectiveness of the dual panel display 201 is the same with that of the dual panel display 200, so those are not illustrated repeatedly as followings.

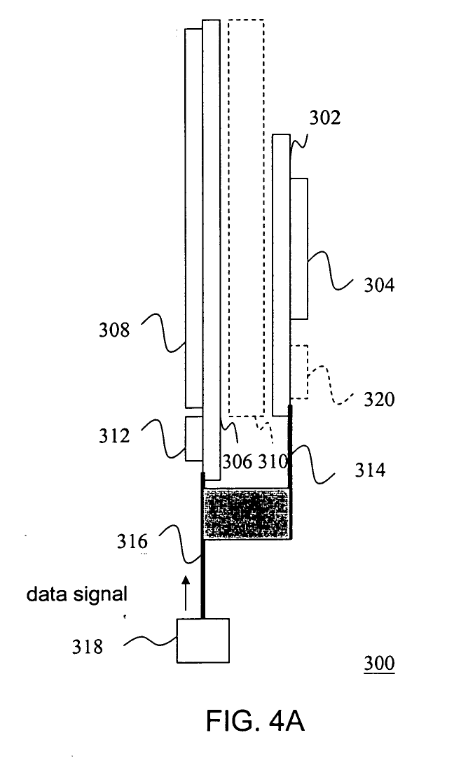

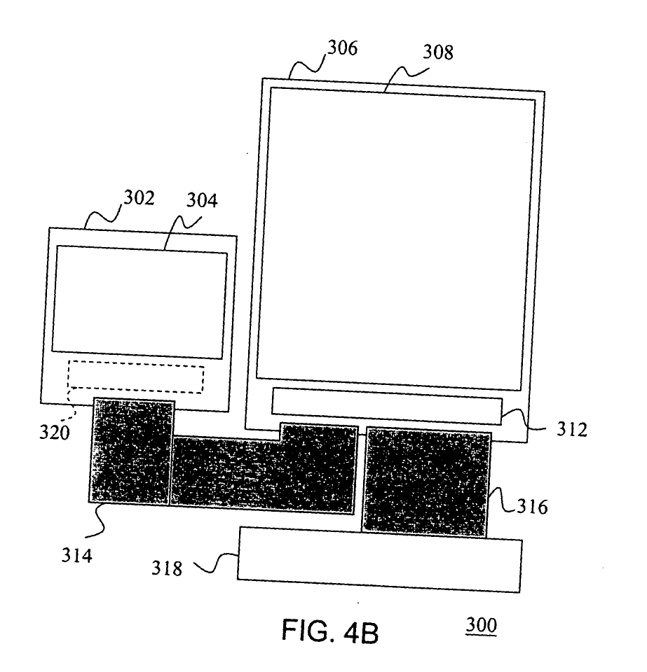

FIG. 4A is a schematic cross-sectional view of a dual panel display according to another embodiment of the present invention. Referring to FIG. 4A, a dual panel display 300 comprises, for example but not limited to, a first panel 302 having a first display area 304, a second panel 306 having a second display area 308, a backlight module 310, an electronic element 312, a FPC 314 and a FPC 316. The dual panel display 300 may be, for example, connected to a control circuit 318. In one embodiment of the present invention, the first panel 302 or the second panel 304 may be LCD or LED display. When the first panel 302 and the second panel 306 are LCD, a backlight module 310 may be disposed between the first panel 302 and the second panel 306 for providing a light source to the first panel 302 and the second panel 306. In addition, the first panel 302 and the second panel 306 can be transparent, reflective or transflective.

FIG. 4B is a schematic expanded view of a dual panel display of FIG. 4A. Referring to FIG. 4B, it is noted that the FPC 314 and the FPC 316 are connected at same side of the second panel 306. Therefore, the data signal transmitted from the control circuit 318 via the FPC 316 is received by the electronic element 312, and then the second panel 306 is driven by the electronic element 312. Thus, the first panel 302 is driven by the electronic element 312 via the FPC 314. In addition, the length or the width of the first panel 302 may be equal to, smaller or larger than that of the second panel 306. In one embodiment of the present invention, the first panel 302 may be, for example but not limited to, a sub panel, and the second panel 306 may be, for example but not limited to, a main panel, or vice versa. In fact, the electronic element 312 mounted on the second panel 306 could be an active element or a passive element, wherein the active element comprises any kinds of integrated circuits (ICs)(such as drive IC) for any other functions such as latching or signal converting, etc.

In one embodiment of the present invention, referring to FIG. 3A and FIG. 3B, a multiplexer 320 may be mounted on the first panel 302 and connected to the FPC 314. In one embodiment of the present invention, when the multiplexer 320 is, for example, an 1:3 multiplexer 320, then three data signal (e.g., the three signals of color R, G, and B) may be transmitted by one line of the FPC 314. Therefore, the number of lines of the FPC 314 may be reduced, i.e., the width of the FPC 314 may also be reduced. In one embodiment of the present invention, the multiplexer 320 comprises, for example but not limited to, an 1:3, 1:6 or 1:9 multiplexer 320.

In one embodiment of the present invention, the dual panel display 300 may be adopted for mobile phone, personal digital assistant, portable computer or notebook computer.

It is noted that, since the electronic element 312, the FPC 316 and the FPC 314 are mounted at the same side of the second panel 306, the total length of the dual panel display 300 may be reduced. For example, the total length of the dual panel display 300 shown in FIG. 3A and FIG. 3B is shorter than that of the dual panel display 100 shown in FIG. 1 for about a length for mounting the FPC 114 (i.e., the distance D shown in FIG. 1).

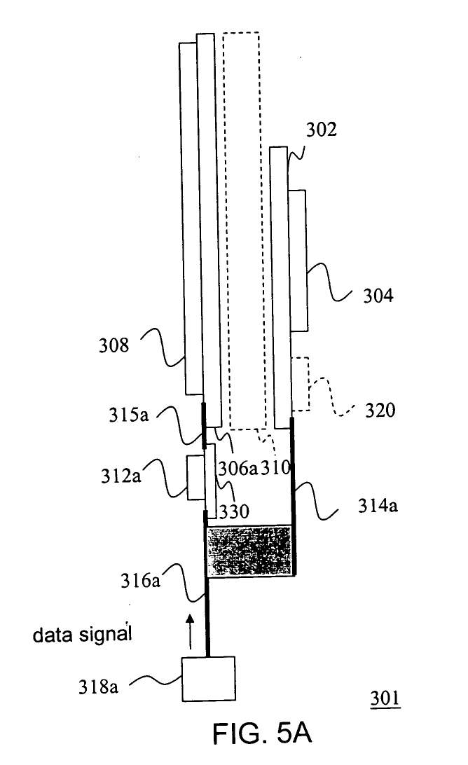

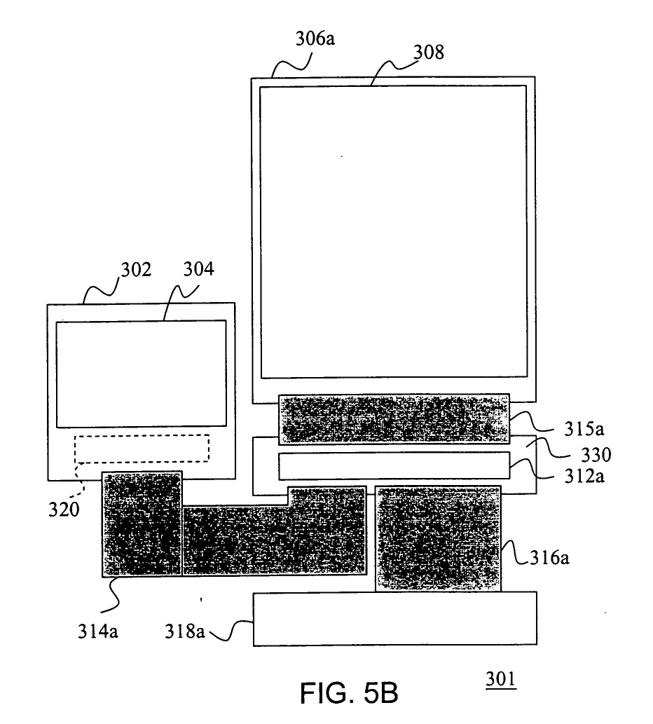

FIG. 5A is a schematic cross-sectional view of a dual panel display according to one embodiment of the present invention, wherein the electronic element is mounted on a PCB. FIG. 5B is a schematic expanded view of a dual panel display of FIG. 5A. Referring to FIGS. 5A and 5B, in one embodiment of the present invention, compared to the above-mentioned dual panel display 300, the electronic element 312a of the dual panel display 301 is mounted on a printed circuit board (PCB) 330 and connected to the PCB 330, wherein the electronic element 312a is connected to the second panel 306a via a third FPC 315a connected to the PCB 330 and the second panel 306a. In addition, the control circuit 318a via the FPC 316a is connected to the PCB 330. The other elements of the dual panel display 301 in FIGS. 5A and 5B are the same with the dual panel display 300 in FIGS. 4A and 4B and the effectiveness thereof are the same, so those are not illustrated repeatedly as followings.

Accordingly, in one embodiment of the present invention, since the electronic element and the first FPC that connected to the electronic element are connected to the second panel having a shorter length, the total length of the dual panel display may be reduced. Alternatively, in another embodiment of the present invention, since the electronic element, the first FPC and the second FPC are substantially mounted at the same side of the second panel or the PCB, the total length of the dual panel display may be reduced.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A dual panel display, comprising:
a first panel having a first display area;
a second panel having a second display area, a length of the first panel being longer than a length of the second panel;
an electronic element connected to the second panel;
a first flexible printed circuit (FPC) connected to the electronic element; and
a second FPC connected between the first panel and the second panel.

2. The dual panel display of claim 1, wherein the electronic element is mounted on the second panel.

3. The dual panel display of claim 1, wherein the electronic element is mounted on a printed circuit board (PCB) and connected to the PCB, and wherein the electronic element is connected to the second panel via a third FPC connected to the PCB and the second panel.

4. The dual panel display of claim 1, wherein the second FPC is connected to the second panel via a side of the second panel that is opposite to the first FPC.

5. The dual panel display of claim 1, wherein the first panel or the second panel comprises a liquid crystal display (LCD), a plasma display or a light emitting diode (LED) display.

6. The dual panel display of claim 4, wherein the first panel and the second panel are liquid crystal displays, and the dual panel display further comprises:
a backlight module disposed between the first panel and the second panel for providing a light source to the first panel and the second panel.

7. The dual panel display of claim 1, wherein further comprising:
a multiplexer mounted on the first panel and connected to the second FPC.

8. The dual panel display of claim 1, wherein the multiplexer comprises an 1:3 multiplexer, an 1:6 multiplexer or an 1:9 multiplexer.

9. The dual panel display of claim 1, wherein a width of the first panel is equal to, shorter or longer than a width of the second panel.

10. The dual panel display of claim 1, wherein the electronic element comprises a passive element or an active element.

11. The dual panel display of claim 10, wherein the active element comprises a drive integrated circuit (IC).

12. A dual panel display, comprising:
a first panel;
a second panel;
a first flexible printed circuit (FPC);
an electronic element connected to the second panel and the first FPC; and
a second FPC connected to the first panel and to the electronic element.

13. The dual panel display of claim 12, wherein the electronic element is mounted on the second panel.

14. The dual panel display of claim 12, wherein the electronic element is mounted on a printed circuit board (PCB) and connected to the PCB, and wherein the electronic element is connected to the second panel via a third FPC connected to the PCB and the second panel.

15. The dual panel display of claim 12, further comprising:
a multiplexer mounted on the first panel and connected to the second FPC.

16. The dual panel display of claim 15, wherein the multiplexer comprises an 1:3 multiplexer, an 1:6 multiplexer or an 1:9 multiplexer.

17. The dual panel display of claim 12, wherein a length of the first panel is equal to, shorter or longer than a length of the second panel.

18. A dual panel display, comprising:
a first panel having a first display area;
a second panel having a second display area;
an electronic element connected to the second panel and a first FPC; and
a second FPC connected to the first panel, wherein the second FPC is connected to the electronic element or a side of the second panel that is opposite to the first FPC, wherein when the second FPC is connected to the side of the second panel, a length of the first panel is longer than a length of the second panel.
